(19) United States
(12) Patent Application Publication
(10) Pub. No.: US 2026/0173132 A1
(43) Pub. Date: Jun. 18, 2026

(54) OPTIMIZED WIRELESS CHANNEL ACCESS USING INITIAL CONTROL FRAME FEEDBACK AND NON-PRIMARY CHANNEL REGULATION

(71) Applicant: Intel Corporation, Santa Clara, CA (US)

(72) Inventor: Laurent Cariou, Milizac (FR)

(21) Appl. No.: 19/536,198

(22) Filed: Feb. 10, 2026

Related U.S. Application Data
(60) Provisional application No. 63/757,449, filed on Feb. 12, 2025.
(60) Provisional application No. 63/767,836, filed on Mar. 6, 2025.

(51) Int. Cl. H04W 74/04; H04W 74/0816; H04W 84/12

(52) U.S. Cl. CPC H04W 74/04; H04W 74/0816; H04W 84/12

(57) ABSTRACT

This disclosure describes systems, methods, and devices related to optimized access. A device may receive, at a non-primary channel access station (NPCA STA), an overlapping basic service set (OBSS) physical protocol data unit (PPDU) on a basic service set primary channel. The device may determine a duration for an NPCA event during which the NPCA STA transitions to an NPCA primary channel. The device may initiate a transmission opportunity (TxOP) with a peer NPCA STA by transmitting a control frame including at least one parameter derived from the received OBSS PPDU.

### CROSS-REFERENCE TO RELATED APPLICATION(S)

This application claims the benefit of U.S. Provisional Application No. 63/757,449, filed Feb. 12, 2025, and U.S. Provisional Application No. 63/767,836, filed Mar. 6, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for optimized access, in accordance with one or more example embodiments of the present disclosure.

FIG. 2 depicts an illustrative schematic diagram for optimized access, in accordance with one or more example embodiments of the present disclosure.

FIG. 3 illustrates a flow of a process for an illustrative optimized access system, in accordance with one or more example embodiments of the present disclosure.

FIG. 4 illustrates a functional diagram of an exemplary communication station that may be suitable for use as a user device, in accordance with one or more example embodiments of the present disclosure.

FIG. 5 illustrates a block diagram of an example machine upon which any of one or more techniques (e.g., methods) may be performed, in accordance with one or more example embodiments of the present disclosure.

FIG. 6 is a block diagram of a radio architecture in accordance with some examples.

FIG. 7 illustrates an example front-end module circuitry for use in the radio architecture of FIG. 6, in accordance with one or more example embodiments of the present disclosure.

FIG. 8 illustrates an example radio IC circuitry for use in the radio architecture of FIG. 6, in accordance with one or more example embodiments of the present disclosure.

FIG. 9 illustrates an example baseband processing circuitry for use in the radio architecture of FIG. 6, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Wi-Fi 9 is positioned as the forthcoming evolution in wireless technology, building upon the advancements of Wi-Fi 8 (802.11bn). The primary objectives for Wi-Fi 9 will align with those established for Wi-Fi 8, focusing on enhancing the reliability of wireless connections, maintaining consistent low latency, and expanding network capacity. However, Wi-Fi 9 aims to push these goals even further, delivering measurable improvements over previous generations. This includes addressing challenges related to operating in unlicensed spectrum shared by numerous legacy devices and technologies, as well as exploring new spectrum opportunities-such as those permitted for Ultra-wideband operation—to enable more efficient spectrum sharing and predictable low-latency traffic. By leveraging frameworks like Multi-Link Operation (MLO) and introducing advanced solutions for spectrum management, Wi-Fi 9 is expected to set new standards for performance, reliability, and efficiency in wireless communications.

The concept of Non-Primary Channel Access (NPCA) is being proposed. Multiple peer STAs (AP and STAs) can switch to the NPCA primary channel when seeing different OBSS frames on the BSS primary channel. This leads to misalignment on the NPCA periods (time during which the NPCA primary channel is operated on).

It has been agreed to define a way for an AP to regulate channel access from NPCA STAs when operating on the NPCA primary channel.

NPCA is a mechanism that enables devices to communicate using an alternative primary channel, particularly when interference is detected on the main channel. In environments where multiple stations, including APs and STAs, operate simultaneously, these devices can switch to the NPCA primary channel upon detecting certain overlapping basic service set (OBSS) frames on the main channel. However, this process can lead to misalignment of NPCA periods, as different stations may transition to the NPCA primary channel at varying times. Such unsynchronized operating periods can cause inefficiencies and conflicts in channel usage. To address these issues, the access point is empowered to regulate how and when NPCA stations access the NPCA primary channel, ensuring orderly communication and minimizing potential conflicts among devices.

Example embodiments of the present disclosure relate to systems, methods, and devices for additional feedback carried in initial control frame (ICF).

In this disclosure, solutions are proposed in order to resolve the misalignments mentioned as well as some simplification of the protocol thanks, in part, to additional information carried in ICF.

Example embodiments of the present disclosure relate to systems, methods, and devices for WiFi8—Regulate channel access with NPCA.

In one or more embodiments, an optimized channel regulation system may define a mode where non-AP STAs have a restricted channel access in UL when operating on the NPCA primary channel., which means that they will mostly be triggered by the associated AP (using UL Trigger-based access).

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

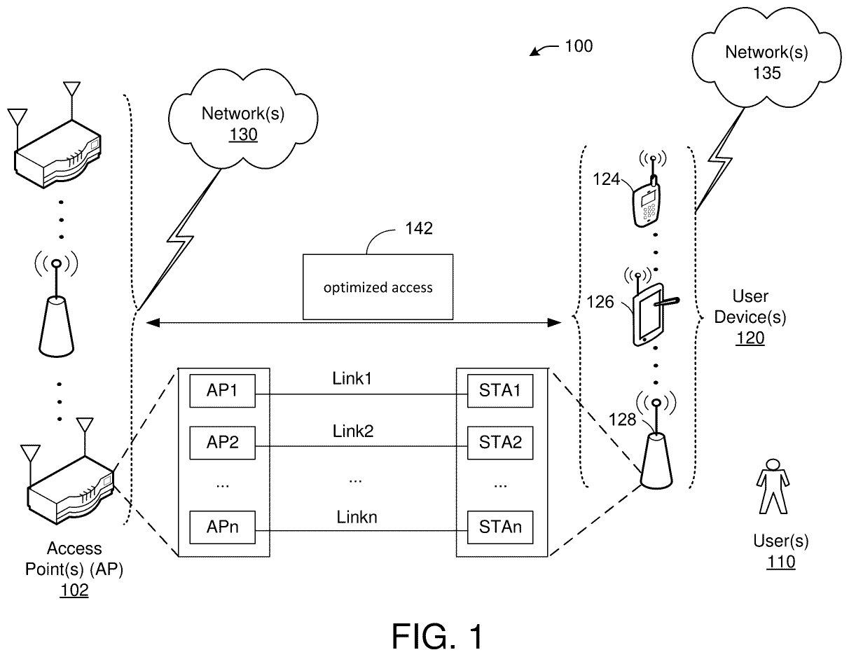

FIG. 1 is a network diagram illustrating an example network environment of optimized access, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

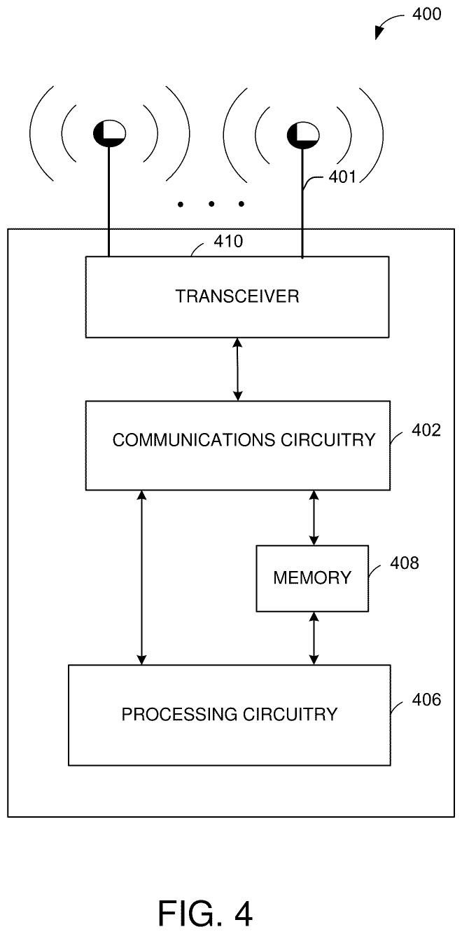

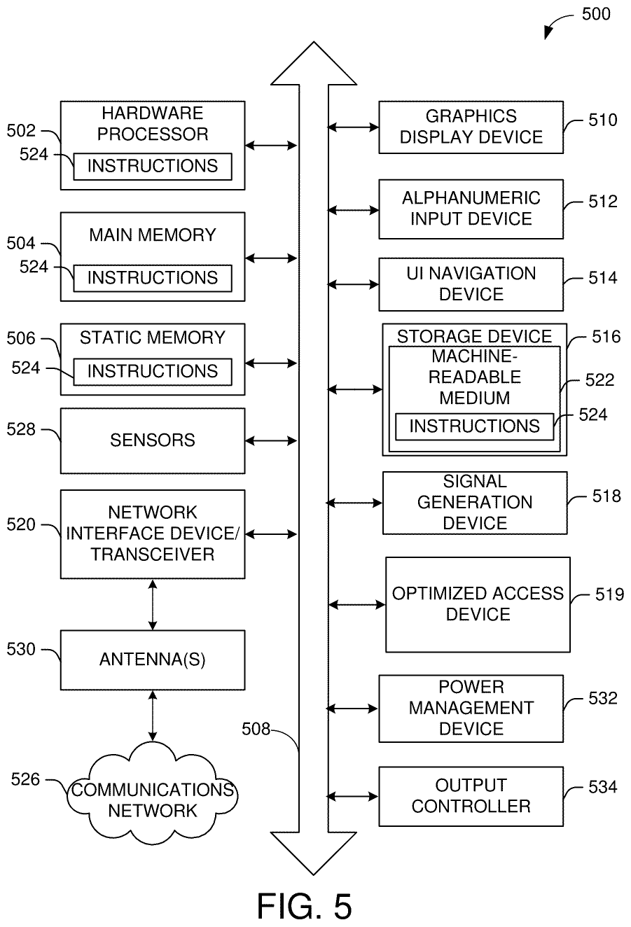

In some embodiments, the user devices 120 and the AP 102 may include one or more computer systems similar to that of the functional diagram of FIG. 4 and/or the example machine/system of FIG. 5.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11 g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an optimized access 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

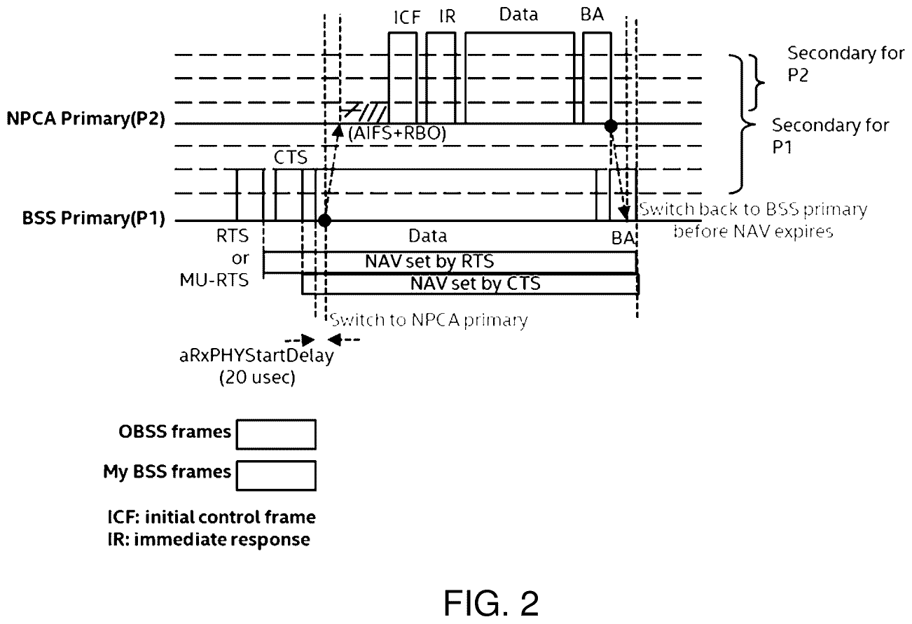

FIG. 2 depicts an illustrative schematic diagram for optimized access, in accordance with one or more example embodiments of the present disclosure.

The concept of Non Primary Channel Access (NPCA) is being proposed, which is illustrated in the following FIG. 2.

Multiple peer STAs (AP and STAs) can switch to the NPCA primary channel when seeing different OBSS frames on the BSS primary channel. This leads to misalignment on the NPCA periods (time during which the NPCA primary channel is operated on).

In one or more embodiments, an optimized access system may facilitate that an NPCA STA shall switch to the NPCA Primary Channel (NPCA PC) only when receiving an OBSS HE/EHT/UHR PPDU, meaning that the option to switch based on the ICF-ICR information that may be carried before that OBSS PPDU may be removed. When an NPCA STA switches to the NPCA PC when receiving an OBSS PPDU (and meeting other conditions), called an NPCA event.

The NPCA Event Duration is the time during which the STA can move outside of the BSS PC (namely transitioning to the NPCA PC, exchanging frames on the NPCA PC and transitioning back to the BSS PC) and be back on the BSS PC at the end of the NCPA Event Duration. It proposed that this NPCA Event Duration is determined as the PPDU duration of the OBSS PPDU whose reception triggers the switch to the NPCA PC (PPDU duration that can be derived from the RxVector L_LENGTH for instance).

After switching to the NPCA PC during an NPCA event, an NPCA STA shall always initiate a TxOP with a peer NPCA STA on the NPCA PC with an initial control frame and this initial control frame shall include at least one of the following:
A field (NPCA Duration field for instance) that includes the Duration of the OBSS PPDU that triggered the NPCA event. Can be the RxVector L_LENGTH of the received OBSS PPDU or a duration field that calculates the duration of the PPDU based on an equation involving multiple RxVectors from the OBSS PPDU).
The BSS color field that was received in the OBSS PPDU PHY Header, corresponding to RxVector BSS_COLOR.

In one or more embodiments, a optimized access system may facilitate that these new fields are included in a Special User Info field that is identified with a special AID value (e.g. 2008) assigned specifically for Feedbacks, and that starts with a Feedback Type field that is set to a special value (e.g. 1) for NPCA parameters (specifically to include this NPCA Max TxOP Duration field). Similarly, the NPCA STA may respond with an initial control response frame being a Multi-STA BA and that includes these parameters as well or that includes a simple indication that these parameters are the same as in the ICF or that they are different. (in synch or not in synch).

In one or more embodiments, an optimized access system may also define a set of rules for responding to an ICF on the NPCA PC:
If an NPCA STA receives an ICF on the NPCA PC that contains an NPCA Duration or a BSS color that does not match the NPCA Duration and BSS color that it has stored during the NPCA Event (based on the OBSS PPDU that it receives to trigger the NPCA event on its end). Then the STA shall not respond. Or it shall respond with an indication in the ICR to indicate that this is not a match. The TxOP Holder can then either continue or discontinue the TxOP.
If an NPCA STA receives an ICF on the NPCA PC that contains an NPCA Duration or a BSS color that does match the NPCA Duration and BSS color that it has stored during the NPCA Event (based on the OBSS PPDU that it receives to trigger the NPCA event on its end). Then the STA shall respond and can propose to include a field that indicates that this is a match and that the 2 STAs switched on the NPCA PC based on the observation of the same OBSS PPDU.

In one or more embodiments, an optimized access system may also define an NPCA Timeout time that is defined in the 802.11 specification (“spec”) or that can be parametrized by a field sent by the STA or the AP for itself or for the BSS (parametrized as a capability so in long term management frames). This NPCA Timeout is the time that a non-AP STA (could also be for AP and non-AP STA) will wait after it arrived on the NPCA PC (after the switch) and if the STA does not receive a frame from its peer NPCA STA (not an ICF nor an ICR frame). If that time elapses without having received a frame from the peer NPCA STA then the NPCA STA will go to power save and will be back in the awake state on the BSS primary channel at the end of the NPCA Event Duration.

If the STA receives a frame during that time from its peer NCPA STA:
If it is addressed to it, it will obviously stay awake and exchange frames with the peer STA
If it is not addressed to it (exchanging with other NPCA STAs), then 2 options:
   Option 1: STA goes in power save right away.
   Option 2: STA sets its NAV based on that received PPDU, and may do intra-PPDU power save on a PPDU basis.
   Option 3: STA still waits until the timeout elapse and goes to doze.

In one or more embodiments, an optimized access system may also define a mechanism so that the non-AP STA can choose the mode of operation it wants to operate on and provides this indication to the AP, carried for instance in the frame used by the non-AP STA to enable the NPCA mode:

In one or more embodiments, a optimized access system may also define a field in the frame used to perform NPCA enablement by the non-AP STA to specify if the STA wants to operate with the timeout or without the timeout (without the timeout, it will stay awake when receiving nothing on the NPCA PC, if it was in the awake state before switching to the NPCA PC).

It has been agreed to define a way for an AP to regulate channel access from NPCA STAs when operating on the NPCA primary channel.

There are a few design goals to respect if such mode is to be defined:

Confidence on the STA side that if it stays awake and transitions to the NPCA channel, it will be scheduled for transmission/reception or at least know very early on if it will be scheduled or not.

Confidence on the STA side that the AP is aware of the buffer status of the STA and of a minimum knowledge of the rate selection (NSS and MCS) for transmissions on the NPCA channel.

In one or more embodiments, an optimized channel regulation system may define a mode where non-AP STAs have a restricted channel access in UL when operating on the NPCA primary channel., which means that they will mostly be triggered by the associated AP (using UL Trigger-based access).

In one or more embodiments, an optimized channel regulation system may facilitate that the AP can enable or disable this NPCA mode for all its associated STAs, or per STA.
If it is done for all STAs, then it will be with a field in the UHR operating element.
If it is done per STA, it will be done with a specific frame sent from the AP to the STA to indicate that it is operating in the regular mode or in the restricted mode.

When an NPCA STA is operating in the restricted mode, the following is proposed:
The NPCA STA shall not access the medium with EDCA (and therefore be only triggered by the AP).
Unless it has traffic that has not been reported in a buffer status report (BSR) to the AP either on the NPCA PC or on the BSS PC (primary channel).

If the STA has such traffic, it is allowed to access the medium in UL with EDCA to transmit this traffic.

It is proposed that this can be for traffic or any AC/TID, or that this exception is only valid for some ACs/TIDs (the highest ACs/TIDs).
Unless the STA is known by the AP as being in doze state, has buffered data on the AP side (indicated in the TIM element in the beacon frame from the AP), and is willing to send a frame indicating that it transitions from doze to awake state (with a frame switch the Power Management mode from 1 to 0 for instance).

If the STA has such traffic, it is allowed to access the medium in UL with EDCA to transmit this traffic.

Regarding the detailed rule for the exception of Traffic that is not reported, the following is proposed:
If the STA has traffic that has been reported to the AP on an AC/TID, then the STA shall not access the medium with EDCA on that AC/TID.
If the STA has traffic that has been reported to the AP on an AC/TID, but new traffic has been added to that AC, then it is possible to either define that the STA shall not access the medium with EDCA on that AC/TID or that it is allowed to access the medium with EDCA for this new traffic
If the STA has traffic that has not been reported to the AP on an AC/TID, then the STA is allowed to access the medium with EDCA.

It is understood that the above descriptions are for the purposes of illustration and are not meant to be limiting.

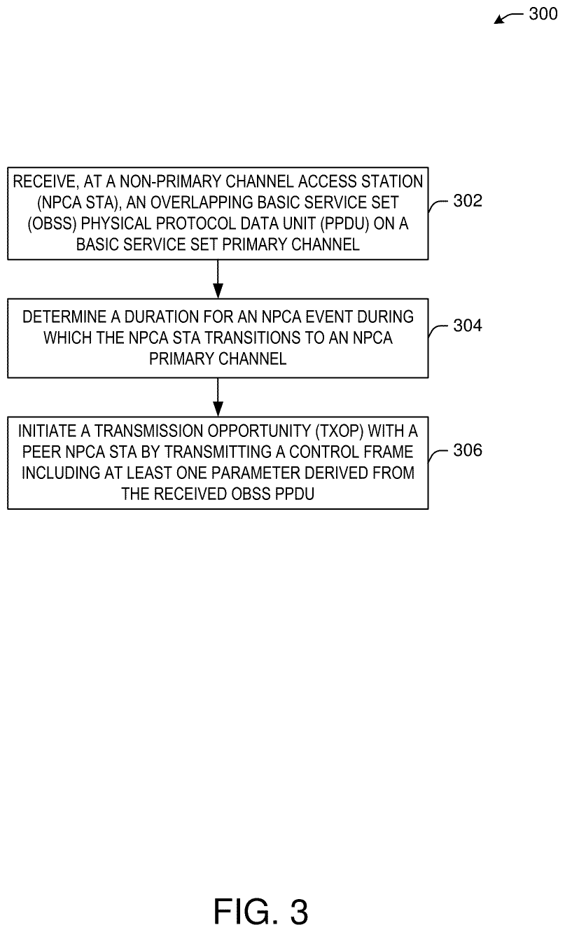

FIG. 3 illustrates a flow of illustrative process 300 for an optimized access system, in accordance with one or more example embodiments of the present disclosure.

At block 302, a device (e.g., the user device(s) 120 and/or the AP 102 of FIG. 1 and/or the optimized access device 519 of FIG. 5) may receive, at a non-primary channel access station (NPCA STA), an overlapping basic service set (OBSS) physical protocol data unit (PPDU) on a basic service set primary channel.

At block XY04, the device may determine a duration for an NPCA event during which the NPCA STA transitions to an NPCA primary channel.

At block XY06, the device may initiate a transmission opportunity (TxOP) with a peer NPCA STA by transmitting a control frame including at least one parameter derived from the received OBSS PPDU.

In one or more embodiments, a device or a system may determine the duration for an NPCA event based on the PPDU duration of a received OBSS PPDU. This approach may address the need for precise timing coordination between stations operating on overlapping service sets, ensuring that transitions to the NPCA primary channel are optimally timed. For instance, the device may utilize the duration value embedded in the received OBSS PPDU to synchronize event timing.

Additionally, in certain scenarios, the device may derive the PPDU duration from a receive vector length field associated with the OBSS PPDU. By leveraging this field, the device may solve challenges related to extracting accurate transmission durations from protocol data units. The device may parse the receive vector to obtain the necessary length information, thereby improving event scheduling accuracy.

In further embodiments, the device may transmit a control frame containing a field that represents the duration for the NPCA event and a basic service set color field obtained from the PPDU physical header of the received OBSS PPDU. This mechanism may facilitate reliable communication of event parameters between peer stations, helping to mitigate misalignment in channel access and color identification. The device may include both duration and color information in the control frame to enable effective peer negotiation.

The device may also structure the control frame to comprise a special user information field identified by a reserved association identifier value, along with a feedback type field specifying NPCA parameters. Such a configuration may address the problem of uniquely identifying control communications and ensuring that feedback is categorized appropriately for NPCA operations. The control frame may thus carry distinct identifiers and feedback types to streamline peer interaction.

In one or more embodiments, the device may receive a control response frame from a peer NPCA STA, which includes an indication of whether the duration for the NPCA event and the basic service set color match those of the received OBSS PPDU. This protocol may enhance coordination and validation between stations, reducing the risk of transmission conflicts. The peer device may confirm matching parameters before proceeding with further transmissions.

In particular situations, the device may withhold a response to an initial control frame when the duration for the NPCA event or the basic service set color included in the initial control frame does not match corresponding stored parameters. This selective response strategy may help prevent erroneous or unintended channel access, thereby reinforcing system integrity. The device may only respond when parameter consistency is verified.

Furthermore, the device may define an NPCA timeout period during which the NPCA STA waits for a frame from the peer NPCA STA after switching to the NPCA primary channel. This timeout mechanism may address the problem of unnecessary channel occupancy and ensure efficient use of network resources. The device may monitor the timeout period and act accordingly if no frame is received.

If no frame is received from the peer NPCA STA during the NPCA timeout period, the device may transition the NPCA STA to a power save state and return to the basic service set primary channel at the end of the NPCA event duration. This solution may optimize power consumption and channel utilization, supporting energy-efficient operation in dynamic network environments. The device may automatically revert to the primary channel and enter power save mode when peer communication does not occur.

It is understood that the above descriptions are for the purposes of illustration and are not meant to be limiting.

FIG. 4 shows a functional diagram of an exemplary communication station 400, in accordance with one or more example embodiments of the present disclosure. In one embodiment, FIG. 4 illustrates a functional block diagram of a communication station that may be suitable for use as an AP 102 (FIG. 1) or a user device 120 (FIG. 1) in accordance with some embodiments. The communication station 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 400 may include communications circuitry 402 and a transceiver 410 for transmitting and receiving signals to and from other communication stations using one or more antennas 401. The communications circuitry 402 may include circuitry that can operate the physical layer (PHY) communications and/or medium access control (MAC) communications for controlling access to the wireless medium, and/or any other communications layers for transmitting and receiving signals. The communication station 400 may also include processing circuitry 406 and memory 408 arranged to perform the operations described herein. In some embodiments, the communications circuitry 402 and the processing circuitry 406 may be configured to perform operations detailed in the above figures, diagrams, and flows.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the communication station 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash-memory devices and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 400 may include one or more of a keyboard, a display, a non-volatile memory port, multiple antennas, a graphics processor, an application processor, speakers, and other mobile device elements. The display may be an LCD screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device.

FIG. 5 illustrates a block diagram of an example of a machine 500 or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), a optimized access device 519, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 502 for generation and processing of the baseband signals and for controlling operations of the main memory 504, the storage device 516, and/or the optimized access device 519. The baseband processor may be provided on a single radio card, a single chip, or an integrated circuit (IC).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

The optimized access device 519 may carry out or perform any of the operations and processes (e.g., process 300) described and shown above.

It is understood that the above are only a subset of what the optimized access device 519 may be configured to perform and that other functions included throughout this disclosure may also be performed by the optimized access device 519.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

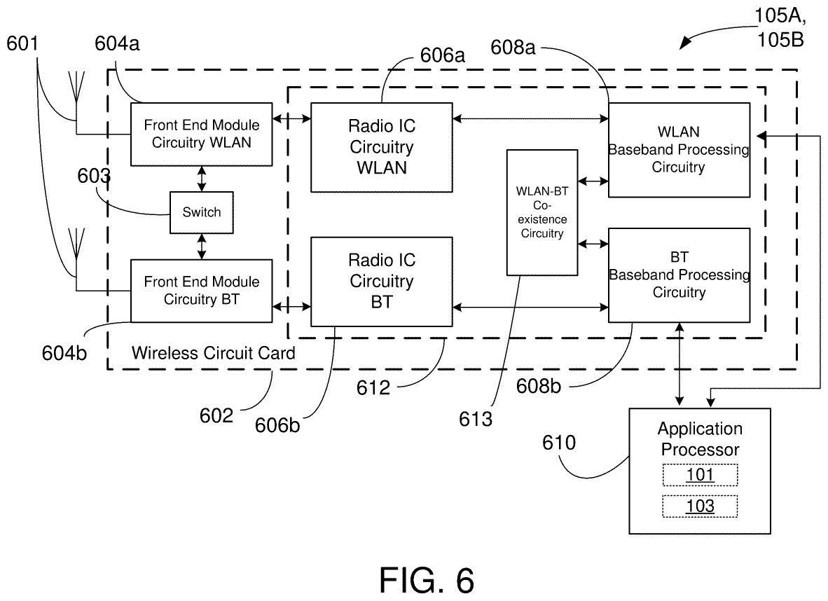

FIG. 6 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 604a-b, radio IC circuitry 606a-b and baseband processing circuitry 608a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 604a-b may include a WLAN or Wi-Fi FEM circuitry 604a and a Bluetooth (BT) FEM circuitry 604b. The WLAN FEM circuitry 604a may include a receive signal path comprising circuitry configured to operate on WLAN RF signals received from one or more antennas 601, to amplify the received signals and to provide the amplified versions of the received signals to the WLAN radio IC circuitry 606a for further processing. The BT FEM circuitry 604b may include a receive signal path which may include circuitry configured to operate on BT RF signals received from one or more antennas 601, to amplify the received signals and to provide the amplified versions of the received signals to the BT radio IC circuitry 606b for further processing. FEM circuitry 604a may also include a transmit signal path which may include circuitry configured to amplify WLAN signals provided by the radio IC circuitry 606a for wireless transmission by one or more of the antennas 601. In addition, FEM circuitry 604b may also include a transmit signal path which may include circuitry configured to amplify BT signals provided by the radio IC circuitry 606b for wireless transmission by the one or more antennas. In the embodiment of FIG. 6, although FEM 604a and FEM 604b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 606a-b as shown may include WLAN radio IC circuitry 606a and BT radio IC circuitry 606b. The WLAN radio IC circuitry 606a may include a receive signal path which may include circuitry to down-convert WLAN RF signals received from the FEM circuitry 604a and provide baseband signals to WLAN baseband processing circuitry 608a. BT radio IC circuitry 606b may in turn include a receive signal path which may include circuitry to down-convert BT RF signals received from the FEM circuitry 604b and provide baseband signals to BT baseband processing circuitry 608b. WLAN radio IC circuitry 606a may also include a transmit signal path which may include circuitry to up-convert WLAN baseband signals provided by the WLAN baseband processing circuitry 608a and provide WLAN RF output signals to the FEM circuitry 604a for subsequent wireless transmission by the one or more antennas 601. BT radio IC circuitry 606b may also include a transmit signal path which may include circuitry to up-convert BT baseband signals provided by the BT baseband processing circuitry 608b and provide BT RF output signals to the FEM circuitry 604b for subsequent wireless transmission by the one or more antennas 601. In the embodiment of FIG. 6, although radio IC circuitries 606a and 606b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 608a-b may include a WLAN baseband processing circuitry 608a and a BT baseband processing circuitry 608b. The WLAN baseband processing circuitry 608a may include a memory, such as, for example, a set of RAM arrays in a Fast Fourier Transform or Inverse Fast Fourier Transform block (not shown) of the WLAN baseband processing circuitry 608a. Each of the WLAN baseband circuitry 608a and the BT baseband circuitry 608b may further include one or more processors and control logic to process the signals received from the corresponding WLAN or BT receive signal path of the radio IC circuitry 606a-b, and to also generate corresponding WLAN or BT baseband signals for the transmit signal path of the radio IC circuitry 606a-b. Each of the baseband processing circuitries 608a and 608b may further include physical layer (PHY) and medium access control layer (MAC) circuitry, and may further interface with a device for generation and processing of the baseband signals and for controlling operations of the radio IC circuitry 606a-b.

Referring still to FIG. 6, according to the shown embodiment, WLAN-BT coexistence circuitry 613 may include logic providing an interface between the WLAN baseband circuitry 608a and the BT baseband circuitry 608b to enable use cases requiring WLAN and BT coexistence. In addition, a switch 603 may be provided between the WLAN FEM circuitry 604a and the BT FEM circuitry 604b to allow switching between the WLAN and BT radios according to application needs. In addition, although the antennas 601 are depicted as being respectively connected to the WLAN FEM circuitry 604a and the BT FEM circuitry 604b, embodiments include within their scope the sharing of one or more antennas as between the WLAN and BT FEMs, or the provision of more than one antenna connected to each of FEM 604a or 604b.

In some embodiments, the front-end module circuitry 604a-b, the radio IC circuitry 606a-b, and baseband processing circuitry 608a-b may be provided on a single radio card, such as wireless radio card 602. In some other embodiments, the one or more antennas 601, the FEM circuitry 604a-b and the radio IC circuitry 606a-b may be provided on a single radio card. In some other embodiments, the radio IC circuitry 606a-b and the baseband processing circuitry 608a-b may be provided on a single chip or integrated circuit (IC), such as IC 612.

In some embodiments, the wireless radio card 602 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 608b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHZ, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

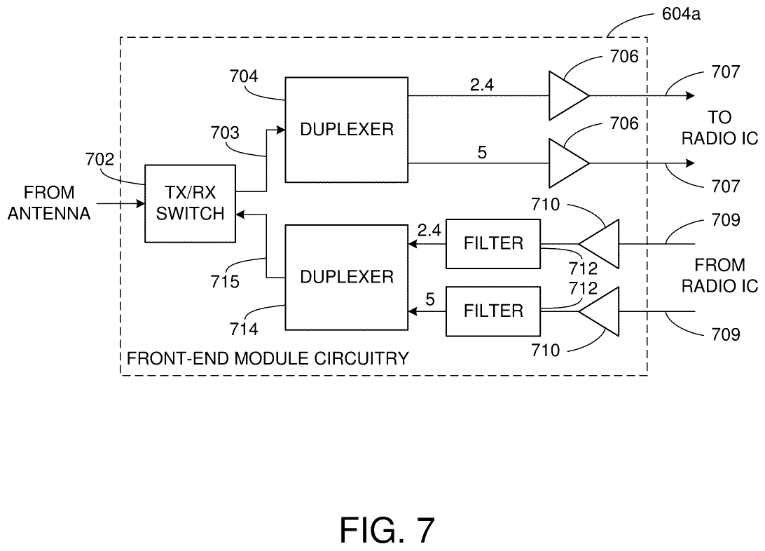

FIG. 7 illustrates WLAN FEM circuitry 604a in accordance with some embodiments. Although the example of FIG. 7 is described in conjunction with the WLAN FEM circuitry 604a, the example of FIG. 7 may be described in conjunction with the example BT FEM circuitry 604b (FIG. 6), although other circuitry configurations may also be suitable.

In some embodiments, the FEM circuitry 604a may include a TX/RX switch 702 to switch between transmit mode and receive mode operation. The FEM circuitry 604a may include a receive signal path and a transmit signal path. The receive signal path of the FEM circuitry 604a may include a low-noise amplifier (LNA) 706 to amplify received RF signals 703 and provide the amplified received RF signals 707 as an output (e.g., to the radio IC circuitry 606a-b (FIG. 6)). The transmit signal path of the circuitry 604a may include a power amplifier (PA) to amplify input RF signals 709 (e.g., provided by the radio IC circuitry 606a-b), and one or more filters 712, such as band-pass filters (BPFs), low-pass filters (LPFs) or other types of filters, to generate RF signals 715 for subsequent transmission (e.g., by one or more of the antennas 601 (FIG. 6)) via an example duplexer 714.

In some dual-mode embodiments for Wi-Fi communication, the FEM circuitry 604a may be configured to operate in either the 2.4 GHz frequency spectrum or the 5 GHz frequency spectrum. In these embodiments, the receive signal path of the FEM circuitry 604a may include a receive signal path duplexer 704 to separate the signals from each spectrum as well as provide a separate LNA 706 for each spectrum as shown. In these embodiments, the transmit signal path of the FEM circuitry 604a may also include a power amplifier 710 and a filter 712, such as a BPF, an LPF or another type of filter for each frequency spectrum and a transmit signal path duplexer 704 to provide the signals of one of the different spectrums onto a single transmit path for subsequent transmission by the one or more of the antennas 601 (FIG. 6). In some embodiments, BT communications may utilize the 2.4 GHz signal paths and may utilize the same FEM circuitry 604a as the one used for WLAN communications.

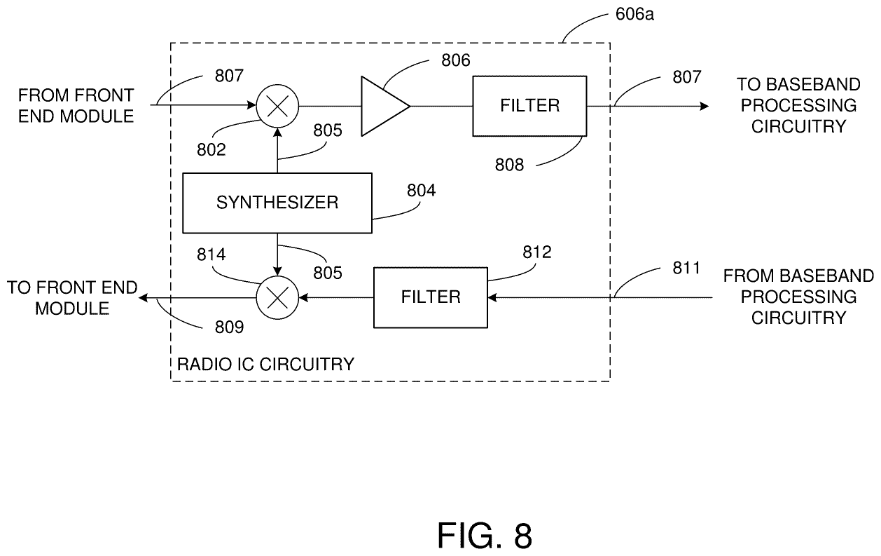

FIG. 8 illustrates radio IC circuitry 606a in accordance with some embodiments. The radio IC circuitry 606a is one example of circuitry that may be suitable for use as the WLAN or BT radio IC circuitry 606a/606b (FIG. 6), although other circuitry configurations may also be suitable. Alternatively, the example of FIG. 8 may be described in conjunction with the example BT radio IC circuitry 606b.

In some embodiments, the radio IC circuitry 606a may include a receive signal path and a transmit signal path. The receive signal path of the radio IC circuitry 606a may include at least mixer circuitry 802, such as, for example, down-conversion mixer circuitry, amplifier circuitry 806 and filter circuitry 808. The transmit signal path of the radio IC circuitry 606a may include at least filter circuitry 812 and mixer circuitry 814, such as, for example, up-conversion mixer circuitry. Radio IC circuitry 606a may also include synthesizer circuitry 804 for synthesizing a frequency 805 for use by the mixer circuitry 802 and the mixer circuitry 814. The mixer circuitry 802 and/or 814 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 8 illustrates only a simplified version of a radio IC circuitry, and may include, although not shown, embodiments where each of the depicted circuitries may include more than one component. For instance, mixer circuitry 814 may each include one or more mixers, and filter circuitries 808 and/or 812 may each include one or more filters, such as one or more BPFs and/or LPFs according to application needs. For example, when mixer circuitries are of the direct-conversion type, they may each include two or more mixers.

In some embodiments, mixer circuitry 802 may be configured to down-convert RF signals 707 received from the FEM circuitry 604a-b (FIG. 6) based on the synthesized frequency 805 provided by synthesizer circuitry 804. The amplifier circuitry 806 may be configured to amplify the down-converted signals and the filter circuitry 808 may include an LPF configured to remove unwanted signals from the down-converted signals to generate output baseband signals 807. Output baseband signals 807 may be provided to the baseband processing circuitry 608a-b (FIG. 6) for further processing. In some embodiments, the output baseband signals 807 may be zero-frequency baseband signals, although this is not a requirement. In some embodiments, mixer circuitry 802 may comprise passive mixers, although the scope of the embodiments is not limited in this respect.

In some embodiments, the mixer circuitry 814 may be configured to up-convert input baseband signals 811 based on the synthesized frequency 805 provided by the synthesizer circuitry 804 to generate RF output signals 709 for the FEM circuitry 604a-b. The baseband signals 811 may be provided by the baseband processing circuitry 608a-b and may be filtered by filter circuitry 812. The filter circuitry 812 may include an LPF or a BPF, although the scope of the embodiments is not limited in this respect.

In some embodiments, the mixer circuitry 802 and the mixer circuitry 814 may each include two or more mixers and may be arranged for quadrature down-conversion and/or up-conversion respectively with the help of synthesizer 804. In some embodiments, the mixer circuitry 802 and the mixer circuitry 814 may each include two or more mixers each configured for image rejection (e.g., Hartley image rejection). In some embodiments, the mixer circuitry 802 and the mixer circuitry 814 may be arranged for direct down-conversion and/or direct up-conversion, respectively. In some embodiments, the mixer circuitry 802 and the mixer circuitry 814 may be configured for super-heterodyne operation, although this is not a requirement.

Mixer circuitry 802 may comprise, according to one embodiment: quadrature passive mixers (e.g., for the in-phase (I) and quadrature phase (Q) paths). In such an embodiment, RF input signal 707 from FIG. 8 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 805 of synthesizer 804 (FIG. 8). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 707 (FIG. 7) may comprise a balanced signal, although the scope of the embodiments is not limited in this respect. The I and Q baseband output signals may be provided to low-noise amplifier, such as amplifier circuitry 806 (FIG. 8) or to filter circuitry 808 (FIG. 8).

In some embodiments, the output baseband signals 807 and the input baseband signals 811 may be analog baseband signals, although the scope of the embodiments is not limited in this respect. In some alternate embodiments, the output baseband signals 807 and the input baseband signals 811 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 804 may be a fractional-N synthesizer or a fractional N/N+1 synthesizer, although the scope of the embodiments is not limited in this respect as other types of frequency synthesizers may be suitable. For example, synthesizer circuitry 804 may be a delta-sigma synthesizer, a frequency multiplier, or a synthesizer comprising a phase-locked loop with a frequency divider. According to some embodiments, the synthesizer circuitry 804 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 804 may be provided by a voltage controlled oscillator (VCO), although that is not a requirement. A divider control input may further be provided by either the baseband processing circuitry 608a-b (FIG. 6) depending on the desired output frequency 805. In some embodiments, a divider control input (e.g., N) may be determined from a look-up table (e.g., within a Wi-Fi card) based on a channel number and a channel center frequency as determined or indicated by the example application processor 610. The application processor 610 may include, or otherwise be connected to, one of the example secure signal converter 101 or the example received signal converter 103 (e.g., depending on which device the example radio architecture is implemented in).

In some embodiments, synthesizer circuitry 804 may be configured to generate a carrier frequency as the output frequency 805, while in other embodiments, the output frequency 805 may be a fraction of the carrier frequency (e.g., one-half the carrier frequency, one-third the carrier frequency). In some embodiments, the output frequency 805 may be a LO frequency (fLO).

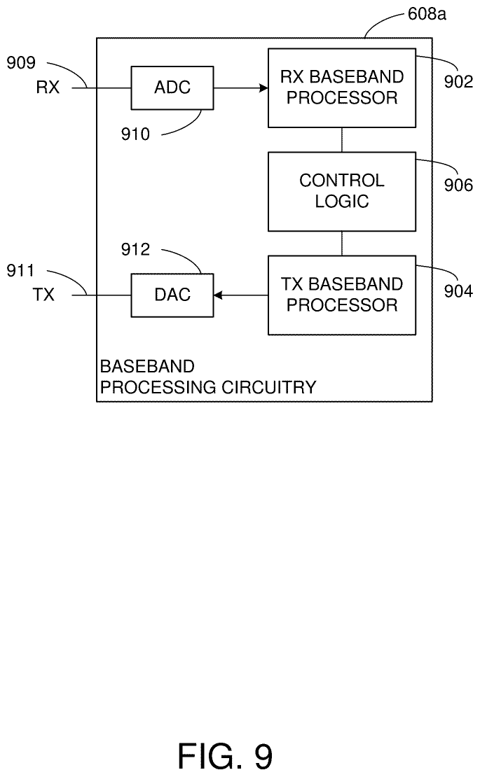

FIG. 9 illustrates a functional block diagram of baseband processing circuitry 608a in accordance with some embodiments. The baseband processing circuitry 608a is one example of circuitry that may be suitable for use as the baseband processing circuitry 608a (FIG. 6), although other circuitry configurations may also be suitable. Alternatively, the example of FIG. 8 may be used to implement the example BT baseband processing circuitry 608b of FIG. 6.

The baseband processing circuitry 608a may include a receive baseband processor (RX BBP) 902 for processing receive baseband signals 809 provided by the radio IC circuitry 606a-b (FIG. 6) and a transmit baseband processor (TX BBP) 904 for generating transmit baseband signals 811 for the radio IC circuitry 606a-b. The baseband processing circuitry 608a may also include control logic 906 for coordinating the operations of the baseband processing circuitry 608a.

In some embodiments (e.g., when analog baseband signals are exchanged between the baseband processing circuitry 608a-b and the radio IC circuitry 606a-b), the baseband processing circuitry 608a may include ADC 910 to convert analog baseband signals 909 received from the radio IC circuitry 606a-b to digital baseband signals for processing by the RX BBP 902. In these embodiments, the baseband processing circuitry 608a may also include DAC 912 to convert digital baseband signals from the TX BBP 904 to analog baseband signals 911.

In some embodiments that communicate OFDM signals or OFDMA signals, such as through baseband processor 608a, the transmit baseband processor 904 may be configured to generate OFDM or OFDMA signals as appropriate for transmission by performing an inverse fast Fourier transform (IFFT). The receive baseband processor 902 may be configured to process received OFDM signals or OFDMA signals by performing an FFT. In some embodiments, the receive baseband processor 902 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 6, in some embodiments, the antennas 601 (FIG. 6) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 601 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.
Example 1 may include a device comprising processing circuitry coupled to storage, the processing circuitry configured to: receive, at a non-primary channel access station (NPCA STA), an overlapping basic service set (OBSS) physical protocol data unit (PPDU) on a basic service set primary channel; determine a duration for an NPCA event during which the NPCA STA transitions to an NPCA primary channel; and initiate a transmission opportunity (TxOP) with a peer NPCA STA by transmitting a control frame including at least one parameter derived from the received OBSS PPDU.
Example 2 may include the device of example 1 and/or some other example(s) herein, wherein the duration for the NPCA event may be determined as a PPDU duration of the received OBSS PPDU.
Example 3 may include the device of example 2 and/or some other example(s) herein, wherein the PPDU duration may be derived from a receive vector length field associated with the OBSS PPDU.
Example 4 may include the device of example 1 and/or some other example(s) herein, wherein the control frame may include a field representing the duration for the NPCA event and a basic service set color field obtained from a PPDU physical header of the received OBSS PPDU.
Example 5 may include the device of example 4 and/or some other example(s) herein, wherein the control frame comprises a special user information field identified by a reserved association identifier value and a feedback type field specifying NPCA parameters.
Example 6 may include the device of example 1 and/or some other example(s) herein, wherein the peer NPCA STA responds with a control response frame including an indication of whether the duration for the NPCA event and a basic service set color match those of the received OBSS PPDU.
Example 7 may include the device of example 1 and/or some other example(s) herein, wherein the processing circuitry may be further configured to withhold a response to an initial control frame when the duration for the NPCA event or a basic service set color included in the initial control frame does not match corresponding stored parameters.
Example 8 may include the device of example 1 and/or some other example(s) herein, wherein the processing circuitry may be further configured to define an NPCA timeout period during which the NPCA STA waits for a frame from the peer NPCA STA after switching to the NPCA primary channel.
Example 9 may include the device of example 8 and/or some other example(s) herein, wherein the NPCA STA transitions to a power save state and returns to the basic service set primary channel at the end of the duration for the NPCA event if no frame may be received from the peer NPCA STA during the NPCA timeout period.
Example 10 may include a non-transitory computer-readable medium storing computer-executable instructions which when executed by one or more processors result in performing operations comprising: receiving, at a non-primary channel access station (NPCA STA), an overlapping basic service set (OBSS) physical protocol data unit (PPDU) on a basic service set primary channel; determining a duration for an NPCA event during which the NPCA STA transitions to an NPCA primary channel; and initiating a transmission opportunity (TxOP) with a peer NPCA STA by transmitting a control frame including at least one parameter derived from the received OBSS PPDU.
Example 11 may include the non-transitory computer-readable medium of example 10 and/or some other example(s) herein, wherein the duration for the NPCA event may be determined as a PPDU duration of the received OBSS PPDU.
Example 12 may include the non-transitory computer-readable medium of example 11 and/or some other example(s) herein, wherein the PPDU duration may be derived from a receive vector length field associated with the OBSS PPDU.
Example 13 may include the non-transitory computer-readable medium of example 10 and/or some other example(s) herein, wherein the control frame may include a field representing the duration for the NPCA event and a basic service set color field obtained from a PPDU physical header of the received OBSS PPDU.
Example 14 may include the non-transitory computer-readable medium of example 13 and/or some other example(s) herein, wherein the control frame comprises a special user information field identified by a reserved association identifier value and a feedback type field specifying NPCA parameters.
Example 15 may include the non-transitory computer-readable medium of example 10 and/or some other example(s) herein, wherein the peer NPCA STA responds with a control response frame including an indication of whether the duration for the NPCA event and a basic service set color match those of the received OBSS PPDU.
Example 16 may include the non-transitory computer-readable medium of example 10 and/or some other example(s) herein, wherein the operations further comprise withholding a response to an initial control frame when the duration for the NPCA event or a basic service set color included in the initial control frame does not match corresponding stored parameters.
Example 17 may include the non-transitory computer-readable medium of example 10 and/or some other example(s) herein, wherein the operations further comprise defining an NPCA timeout period during which the NPCA STA waits for a frame from the peer NPCA STA after switching to the NPCA primary channel.
Example 18 may include the non-transitory computer-readable medium of example 17 and/or some other example(s) herein, wherein the NPCA STA transitions to a power save state and returns to the basic service set primary channel at the end of the duration for the NPCA event if no frame may be received from the peer NPCA STA during the NPCA timeout period.
Example 19 may include a method comprising: receiving, at a non-primary channel access station (NPCA STA), an overlapping basic service set (OBSS) physical protocol data unit (PPDU) on a basic service set primary channel; determining a duration for an NPCA event during which the NPCA STA transitions to an NPCA primary channel; and initiating a transmission opportunity (TxOP) with a peer NPCA STA by transmitting a control frame including at least one parameter derived from the received OBSS PPDU.
Example 20 may include the method of example 19 and/or some other example(s) herein, wherein the duration for the NPCA event may be determined as a PPDU duration of the received OBSS PPDU.
Example 21 may include the method of example 20 and/or some other example(s) herein, wherein the PPDU duration may be derived from a receive vector length field associated with the OBSS PPDU.
Example 22 may include the method of example 19 and/or some other example(s) herein, wherein the control frame may include a field representing the duration for the NPCA event and a basic service set color field obtained from a PPDU physical header of the received OBSS PPDU.
Example 23 may include the method of example 22 and/or some other example(s) herein, wherein the control frame comprises a special user information field identified by a reserved association identifier value and a feedback type field specifying NPCA parameters.
Example 24 may include the method of example 19 and/or some other example(s) herein, wherein the peer NPCA STA responds with a control response frame including an indication of whether the duration for the NPCA event and a basic service set color match those of the received OBSS PPDU.
Example 25 may include the method of example 19 and/or some other example(s) herein, the method further comprising withholding a response to an initial control frame when the duration for the NPCA event or a basic service set color included in the initial control frame does not match corresponding stored parameters.
Example 26 may include the method of example 19 and/or some other example(s) herein, the method further comprising defining an NPCA timeout period during which the NPCA STA waits for a frame from the peer NPCA STA after switching to the NPCA primary channel.
Example 27 may include the method of example 26 and/or some other example(s) herein, wherein the NPCA STA transitions to a power save state and returns to the basic service set primary channel at the end of the duration for the NPCA event if no frame may be received from the peer NPCA STA during the NPCA timeout period.
Example 28 may include an apparatus comprising means for: receiving, at a non-primary channel access station (NPCA STA), an overlapping basic service set (OBSS) physical protocol data unit (PPDU) on a basic service set primary channel; determining a duration for an NPCA event during which the NPCA STA transitions to an NPCA primary channel; and initiating a transmission opportunity (TxOP) with a peer NPCA STA by transmitting a control frame including at least one parameter derived from the received OBSS PPDU.
Example 29 may include the apparatus of example 28 and/or some other example(s) herein, wherein the duration for the NPCA event may be determined as a PPDU duration of the received OBSS PPDU.
Example 30 may include the apparatus of example 29 and/or some other example(s) herein, wherein the PPDU duration may be derived from a receive vector length field associated with the OBSS PPDU.
Example 31 may include the apparatus of example 28 and/or some other example(s) herein, wherein the control frame may include a field representing the duration for the NPCA event and a basic service set color field obtained from a PPDU physical header of the received OBSS PPDU.
Example 32 may include the apparatus of example 31 and/or some other example(s) herein, wherein the control frame comprises a special user information field identified by a reserved association identifier value and a feedback type field specifying NPCA parameters.
Example 33 may include the apparatus of example 28 and/or some other example(s) herein, wherein the peer NPCA STA responds with a control response frame including an indication of whether the duration for the NPCA event and a basic service set color match those of the received OBSS PPDU.
Example 34 may include the apparatus of example 28 and/or some other example(s) herein, further comprising withholding a response to an initial control frame when the duration for the NPCA event or a basic service set color included in the initial control frame does not match corresponding stored parameters.
Example 35 may include the apparatus of example 28 and/or some other example(s) herein, further comprising defining an NPCA timeout period during which the NPCA STA waits for a frame from the peer NPCA STA after switching to the NPCA primary channel.
Example 36 may include the apparatus of example 35 and/or some other example(s) herein, wherein the NPCA STA transitions to a power save state and returns to the basic service set primary channel at the end of the duration for the NPCA event if no frame may be received from the peer NPCA STA during the NPCA timeout period.
Example 37 may include one or more non-transitory computer-readable media comprising instructions to cause an electronic device, upon execution of the instructions by one or more processors of the electronic device, to perform one or more elements of a method described in or related to any of examples 1-14, or any other method or process described herein.
Example 38 may include an apparatus comprising logic, modules, and/or circuitry to perform one or more elements of a method described in or related to any of examples 1-14, or any other method or process described herein.
Example 39 may include a method, technique, or process as described in or related to any of examples 1-14, or portions or parts thereof.
Example 40 may include an apparatus comprising: one or more processors and one or more computer readable media comprising instructions that, when executed by the one or more processors, cause the one or more processors to perform the method, techniques, or process as described in or related to any of examples 1-14, or portions thereof.
Example 41 may include a method of communicating in a wireless network as shown and described herein.
Example 42 may include a system for providing wireless communication as shown and described herein.
Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
receive, at a non-primary channel access station (NPCA STA), an overlapping basic service set (OBSS) physical protocol data unit (PPDU) on a basic service set primary channel;
determine a duration for an NPCA event during which the NPCA STA transitions to an NPCA primary channel; and
initiate a transmission opportunity (TxOP) with a peer NPCA STA by transmitting a control frame including at least one parameter derived from the received OBSS PPDU.

2. The device of claim 1, wherein the duration for the NPCA event is determined as a PPDU duration of the received OBSS PPDU.

3. The device of claim 2, wherein the PPDU duration is derived from a receive vector length field associated with the OBSS PPDU.

4. The device of claim 1, wherein the control frame includes a field representing the duration for the NPCA event and a basic service set color field obtained from a PPDU physical header of the received OBSS PPDU.

5. The device of claim 4, wherein the control frame comprises a special user information field identified by a reserved association identifier value and a feedback type field specifying NPCA parameters.

6. The device of claim 1, wherein the peer NPCA STA responds with a control response frame including an indication of whether the duration for the NPCA event and a basic service set color match those of the received OBSS PPDU.

7. The device of claim 1, wherein the processing circuitry is further configured to withhold a response to an initial control frame when the duration for the NPCA event or a basic service set color included in the initial control frame does not match corresponding stored parameters.

8. The device of claim 1, wherein the processing circuitry is further configured to define an NPCA timeout period during which the NPCA STA waits for a frame from the peer NPCA STA after switching to the NPCA primary channel.

9. The device of claim 8, wherein the NPCA STA transitions to a power save state and returns to the basic service set primary channel at the end of the duration for the NPCA event if no frame is received from the peer NPCA STA during the NPCA timeout period.

10. A non-transitory computer-readable medium storing computer-executable instructions which when executed by one or more processors result in performing operations comprising:
receiving, at a non-primary channel access station (NPCA STA), an overlapping basic service set (OBSS) physical protocol data unit (PPDU) on a basic service set primary channel;
determining a duration for an NPCA event during which the NPCA STA transitions to an NPCA primary channel; and
initiating a transmission opportunity (TxOP) with a peer NPCA STA by transmitting a control frame including at least one parameter derived from the received OBSS PPDU.

11. The non-transitory computer-readable medium of claim 10, wherein the duration for the NPCA event is determined as a PPDU duration of the received OBSS PPDU.

12. The non-transitory computer-readable medium of claim 11, wherein the PPDU duration is derived from a receive vector length field associated with the OBSS PPDU.

13. The non-transitory computer-readable medium of claim 10, wherein the control frame includes a field representing the duration for the NPCA event and a basic service set color field obtained from a PPDU physical header of the received OBSS PPDU.

14. The non-transitory computer-readable medium of claim 13, wherein the control frame comprises a special user information field identified by a reserved association identifier value and a feedback type field specifying NPCA parameters.

15. The non-transitory computer-readable medium of claim 10, wherein the peer NPCA STA responds with a control response frame including an indication of whether the duration for the NPCA event and a basic service set color match those of the received OBSS PPDU.

16. The non-transitory computer-readable medium of claim 10, wherein the operations further comprise withholding a response to an initial control frame when the duration for the NPCA event or a basic service set color included in the initial control frame does not match corresponding stored parameters.

17. The non-transitory computer-readable medium of claim 10, wherein the operations further comprise defining an NPCA timeout period during which the NPCA STA waits for a frame from the peer NPCA STA after switching to the NPCA primary channel.

18. The non-transitory computer-readable medium of claim 17, wherein the NPCA STA transitions to a power save state and returns to the basic service set primary channel at the end of the duration for the NPCA event if no frame is received from the peer NPCA STA during the NPCA timeout period.

19. A method comprising:
receiving, at a non-primary channel access station (NPCA STA), an overlapping basic service set (OBSS) physical protocol data unit (PPDU) on a basic service set primary channel;
determining a duration for an NPCA event during which the NPCA STA transitions to an NPCA primary channel; and
initiating a transmission opportunity (TxOP) with a peer NPCA STA by transmitting a control frame including at least one parameter derived from the received OBSS PPDU.

20. The method of claim 19, wherein the duration for the NPCA event is determined as a PPDU duration of the received OBSS PPDU.
